(19) United States
(12) Patent Application Publication
(10) Pub. No.: US 2011/0234988 A1
(43) Pub. Date: Sep. 29, 2011

(54) LIGHT SOURCE AND PROJECTOR

(75) Inventor: Takuji KAWAI, Shiojiri-shi (JP)

(73) Assignee: SEIKO EPSON CORPORATION, TOKYO (JP)

(21) Appl. No.: 13/071,873

(22) Filed: Mar. 25, 2011

(30) Foreign Application Priority Data
Mar. 29, 2010 (JP) 2010-075011
Oct. 8, 2010 (JP) 2010-228184

(51) Int. Cl. G03B 21/16; F21V 7/00

(52) U.S. Cl. 353/52; 362/298

(57) ABSTRACT

A light source including an arc tube having a light-emitting portion and first and second sealing portions provided on both sides of the light-emitting portion along the optical axis; a reflector configured to reflect a luminous flux emitted from the light-emitting portion; and a sub-mirror arranged so as to oppose the reflector, including a main body portion provided with a reflecting surface configured to reflect part of a luminous flux emitted from the arc tube, a mounting portion configured to be fixed to the second sealing portion, and a cooling air ventilating portion penetrating through the mounting portion in the direction of the optical axis at least on the opposite side from the direction of gravitational force.

### CROSS-REFERENCE

The entire disclosure of Japanese Patent Application No. 2010-075011 filed Mar. 29, 2010 and No. 2010-228184 filed Oct. 8, 2010 are expressly incorporated by reference herein.

### BACKGROUND

1. Technical Field

The present invention relates to a light source having a sub-mirror around an arc tube and having an air ventilating portion for cooling the sub-mirror, and a projector employing the light source.

2. Related Art

In a light source in the related art having a sub-mirror around an arc tube, cement for fixing the arc tube and the sub-mirror is subjected to thermal expansion due to heat generation in the arc tube, and the arc tube or the sub-mirror may be broken due to a stress in association with the thermal expansion. Therefore, in order to avoid such damages, a configuration in which the sub-mirror is formed with an insertion hole or a cutout is known (see JP-A-2005-309084).

However, in the case of JP-A-2005-309084), even though the breakage or the like of the sub-mirror in association with the stress can be avoided, temperature rise of the sub-mirror or the periphery thereof due to the heat generation in the arc tube can not necessarily be restrained sufficiently. When the temperatures of the sub-mirror or the periphery thereof positioned in the vicinity of a heat generating position of the arc tube rise, the temperatures specifically of the sub-mirror and the light-emitting portion of the arc tube in the vicinity thereof tend to rise, and hence harmful effects such as devitrification of the light-emitting portion of the arc tube may be resulted.

### SUMMARY

An advantage of some aspects of the invention is that a light source in which cooling of a sub-mirror and the periphery thereof is achieved adequately, and alignment of the arc tube and the sub-mirror is adequately achieved, and a projector using the same are provided.

According to an aspect of the invention, there is provided a light source including: (a) an arc tube having a light-emitting portion having a discharge space in the interior thereof and first and second sealing portions provided on both sides of the light-emitting portion along an optical axis; (b) a reflector arranged so that a center where the optical axis passes is located on the side of the first sealing portion with respect to the light-emitting portion and having a main reflecting surface configured to reflect a luminous flux emitted from the light-emitting portion; and (c) a sub-mirror arranged on the side of the second sealing portion so as to oppose the reflector, including a main body portion provided with a sub-reflecting surface configured to reflect part of a luminous flux emitted from the arc tube toward the discharge space, a mounting portion configured to be fixed to the second sealing portion and supporting the main body portion, and a cooling air ventilating portion penetrating through the mounting portion in the direction of the optical axis at least on the opposite side from the direction of gravitational force.

According to the light source described above, since the sub-mirror includes the cooling air ventilation portion penetrating through the mounting portion configured to support the main body portion in the direction of optical axis at least on the side opposite from the direction of gravitational force, the cooling air can be flowed between the portion of the light-emitting portion on the opposite side from the direction of gravitational force, which is liable to accumulate heat, and the sub-mirror. Accordingly, cooling of the sub-mirror and the periphery thereof are achieved appropriately.

In a specific aspect of the invention, the sub-mirror further may include an auxiliary air ventilating portion penetrating in the direction of the optical axis on the side of the direction of the gravitational force. With the provision of the auxiliary air ventilating portion, cooling effect for the sub-mirror and the periphery thereof can further be enhanced.

In another aspect of the invention, the second sealing portion may have a cylindrical shape, and the mounting portion may include a supporting portion having an ellipsoidal-shaped cross section and allowing insertion of the second sealing portion. In this configuration, since the supporting portion has an ellipsoidal-shaped cross-section, that is, inner periphery of an ellipsoidal shape, the air ventilating portion can be formed relatively easily within a desired range on the longer diameter side.

In still another aspect of the invention, the mounting portion may include a supporting portion configured to allow insertion of the second sealing portion, an adhesive to be filled in a space between the second sealing portion and the supporting portion, and a partition configured to restrict a range to be bonded with the adhesive and define the air ventilating portion. In this configuration, the air ventilating portion can be formed within a predetermined range by restricting the range to be bonded by the partition.

In yet another aspect of the invention, the partition may be formed of a resilient member. In this configuration, even when the partition is disposed in abutment with the inner periphery of the supporting portion and the outer periphery of the second sealing portion, the alignment between the arc tube and the sub-mirror is achieved adequately by the resilient deformation of the partition.

In still yet another aspect of the invention, the distance that the supporting portion including the partition can be moved toward a center of outer diameter of the second sealing portion may be 0.5 mm or more. In this configuration, since the distance (clearance) required for the alignment between the arc tube and the sub-mirror is secured, the alignment can be performed adequately without being affected by the material of the partition.

In further another aspect of the invention, the cooling air ventilating portion may be a cutout provided on the side of the mounting portion of the sub-mirror. In this configuration, a required amount of the cooing air for cooling the portion between the sub-mirror and the arc tube can be flowed by adjusting the dimensions of the cutout.

In still further another aspect of the invention, an air flow control panel configured to direct the cooling air from the side of the reflector to the side of the sub-mirror along the optical axis in cooperation with a inner surface of the reflector may be further provided. In this configuration, the cooling air can be directed reliably between the sub-mirror and the arc tube by the air flow control panel.

According to yet further another aspect of the invention, there is provided a projector including the light source according to any of the above aspects and configured to perform image projection by modulating light emitted from the light source according to image information and forming image light. In this configuration, since the projector includes the light source as described above, adequate cooling is performed in a sub-mirror in the light source, and hence a luminous flux in the satisfactory state is emitted, so that the projection of the satisfactory image is achieved.

In a specific aspect, the projector may further include a cooling device configured to blow the cooling air toward the reflector. In this configuration, the cooling air required for cooling the light-emitting portion can be generated by the cooling device.

### BRIEF DESCRIPTION OF THE DRAWINGS

The invention will be described with reference to the accompanying drawings wherein like numbers reference like elements.

FIG. 1 is a cross-sectional view for explaining a light source according to a first embodiment.

FIG. 2A is a perspective view for explaining an example of a sub-mirror of the light source.

FIG. 2B is a front view for explaining the example of the sub-mirror of the light source.

FIG. 3 is a front view for explaining another example of the sub-mirror.

FIG. 4 is a front view for explaining another example of the sub-mirror.

FIG. 5 is a conceptual drawing for explaining a configuration of an optical system of a projector according to the first embodiment in which the light source is integrated.

FIG. 6A is a perspective view for explaining an example of the light source according to a second embodiment.

FIG. 6B is a front view for explaining the example of the light source according to the second embodiment.

FIG. 7 is a cross-sectional view for explaining a modification of the light source.

### DESCRIPTION OF EXEMPLARY EMBODIMENTS

### First Embodiment

Hereinafter, a light source will be described from the light source and a projector including the light source integrated therein according to a first embodiment.

### A. Light Source

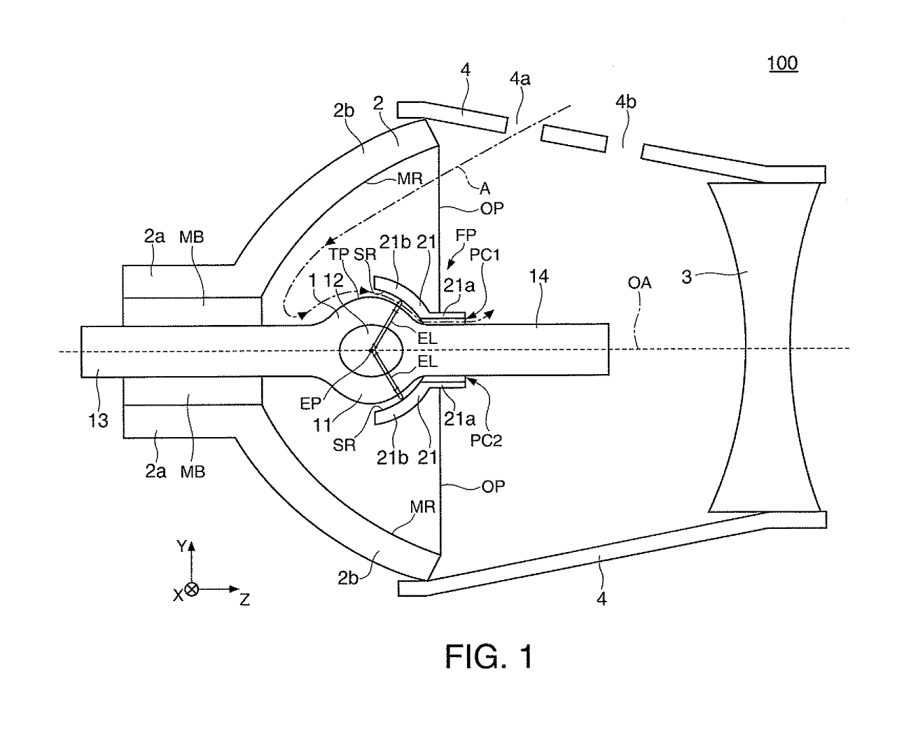

As shown in FIG. 1, a light source 100 according to a first embodiment includes an electric-discharge light emitting type arc tube 1, a reflector 2 as an ellipsoidal-shaped main light-reflecting mirror, a concave lens 3 for collimation, a sub-mirror 21 as a spherical-shaped sub light-reflecting mirror, and a housing 4 for storage.

In the light source 100, the arc tube 1 is an electric-discharge light emitting type lamp such as a high pressure mercury lamp or a metal halide lamp, for example. The arc tube 1 is formed of a translucent quartz glass tube swelling at a center portion thereof into a spherical shape, and includes a light-emitting portion 11 configured to emit illumination light, and column-shaped first and second sealing portions 13 and 14 extending to both sides of the light-emitting portion 11 along an optical axis OA.

In the arc tube 1, a discharge space 12 formed in the light-emitting portion 11 contains gas including, mercury, rare gas, halogen and so on encapsulated therein. A pair of electrodes, not shown, are encapsulated in the discharge space 12. When an adequate voltage is applied to the pair of electrodes, ark discharge occurs and hence light is emitted radially at a high intensity from a light-emitting center EP in the discharge space 12.

The reflector 2 is a main light-reflecting mirror configured to reflect light emitted from the arc tube 1 and converge the same. The reflector 2 is arranged coaxially with the arc tube 1. In other words, a rotational symmetrical axis of the reflector 2 is arranged on the same optical axis OA, that is, on an axial line of the arc tube 1. The reflector 2 is arranged rearward of the arc tube 1, that is, on the side of the first sealing portion 13. In other words, the center of the reflector 2 where the optical axis OA extends is arranged on the side of the first sealing portion 13. The center of the reflector 2 exists in a space surrounded by a concave surface of a main reflecting portion 2b on the rotational symmetrical axis of the concave surface. The reflector 2 mainly reflects part of light emitted from the light-emitting portion 11 of the arc tube 1, that is, light emitted from the light-emitting portion 11 toward the first sealing portion 13 intensively toward the second sealing portion 14. The reflector 2 is an integrated mold formed of quartz glass, and includes a neck-shaped portion 2a through which the first sealing portion 13 of the arc tube 1 is inserted and the main reflecting portion 2b having the shape of an ellipsoidal curved surface and extending from the neck-shaped portion 2a toward the side. The neck-shaped portion 2a allows insertion of the first sealing portion 13 and fixation of the main reflecting portion 2b with the light-emitting portion 11 in alignment therewith by filling a gap formed with respect to the first sealing portion 13 with an inorganic adhesive MB. The inner surface of the main reflecting portion 2b is machined into the shape of the ellipsoidal curved surface, and is formed with a reflecting surface MR on the surface thereof. An opening OP provided on the +Z side of the reflector 2 corresponds to an air-ventilation port for guiding cooling air A from an air supply port 4a of the housing 4, described later, to the periphery of the light-emitting portion 11.

The concave lens 3 is arranged coaxially with the reflector 2 so as to oppose the same. In other words, the optical axis of the concave lens 3 is arranged on the optical axis OA which matches the rotational symmetrical axis of the reflector 2. The concave lens 3 is a collimator lens configured to collimate light reflected from the reflector 2 before it exits therefrom.

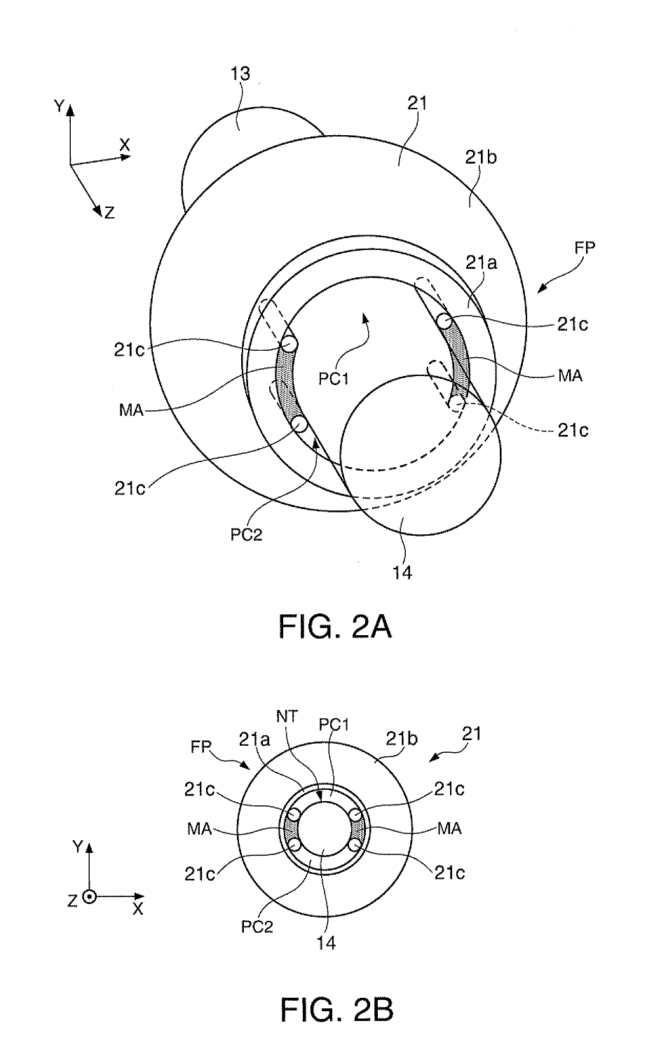

The sub-mirror 21 is a sub-light reflecting mirror configured to return a luminous flux emitted forward from the light-emitting portion 11 to the light-emitting portion 11. The sub-mirror 21 includes a mounting portion FP to be fixed to the periphery of the second sealing portion 14 and a sub-reflecting portion 21b as a main body portion of the sub-mirror 21 which is supported by the mounting portion FP and covers the light exiting side of the light-emitting portion 11, that is, substantially front half thereof. The mounting portion FP includes a supporting portion 21a configured to support a root portion of the mounting portion FP, an inorganic adhesive MA or the like (see FIG. 2A). Here, the sub-reflecting portion 21b and the supporting portion 21a are members formed integrally of quartz glass. The mounting portion FP is formed with a cooling air ventilating portion PC1 which penetrates in the direction of the optical axis on the opposite side (upper side) of the direction of the gravitational force, and an auxiliary air ventilating portion PC2 penetrating in the direction of the optical axis on the side of the direction of gravitational force (lower side). The inner surface of the sub-reflecting portion 21b is machined into a spherical shape, and is formed with a reflecting surface SR on the surface thereof. As illustrated, most part of light EL having components in the forward direction, that is, in the +Z direction out of the luminous flux emitted from the light-emitting center EP is emitted from the light-emitting portion 11, and is reflected from the reflecting surface SR of the sub-reflecting portion 21b, and then is returned back to the light-emitting center EP again. Accordingly, the light EL is emitted from the light-emitting portion 11 as light having components in the backward direction, that is, in the −Z direction, so that the efficiency of usage of the illumination light can be enhanced. However, the sub-mirror 21 and the light-emitting portion 11 in the vicinity thereof are specifically liable to accumulate heat due to radiant heat from the light LE and the light-emitting portion 11. Therefore, in this embodiment, with the provision of the cooling air ventilating portion PC1 penetrating through the optical axis as illustrated, the cooling air A is allowed to pass between the sub-mirror 21 and the light-emitting portion 11.

The housing 4 is formed of resin or the like, and is fixed in a state in which the reflector 2 and the concave lens 3 are aligned. The housing 4 blocks the internal space formed between the reflector 2 and the concave lens 3 from the periphery, and prevents a useless luminous flux from the arc tube 1 from leaking out as stray light. As shown in FIG. 1, a pair of openings, that is, the air supply port 4a and an air discharge port 4b are formed on one of side walls of the housing 4, that is, a wall surface in the +Y direction. The air supply port 4a is used for intake the cooling air A from the outside, and the air discharge port 4b is used for discharging the air after cooling to the outside. The air supply port 4a and the air discharge port 4b are arranged on the +Y side, that is, an upper side opposite from the direction of gravitational force with respect to a plane containing the optical axis OA and extending in parallel with the XZ plane. That is, the air supply port 4a and the air discharge port 4b are intended to cool mainly an upper half of the internal space of the housing 4.

In FIG. 1, the light source 100 is arranged so that the direction of gravitational force corresponds to the −Y direction. Therefore, an upper portion TP of the light-emitting portion 11 of the arc tube 1, which is arranged on the opposite side from the direction of gravitational force, that is, on the +Y side, generates a largest amount of heat, and may cause devitrification. Therefore, it is desired to control the flow of the cooling air A so as to cool intensively the upper portion TP of the light-emitting portion 11 and the periphery thereof.

In this configuration, the light source 100 intakes the cooling air A from the outside via the air supply port 4a provided on the +Y side of the housing 4 as shown in FIG. 1. The cooling air A taken from the outside is introduced from the opening OP of the reflector 2 into the interior of the reflector 2, and partly passes through the cooling air ventilating portion PC1 provided in the sub-mirror 21.

Referring now to FIG. 2A and FIG. 2B, an example of a structure of the sub-mirror 21 will be described in detail. As shown in FIG. 2A and FIG. 23, the mounting portion FP of the sub-mirror 21 includes the supporting portion 21a, the inorganic adhesive MA, which is an adhesive to be filled in a gap between the supporting portion 21a and the second sealing portion 14, and four partitions 21c configured to restrict an area to be bonded with the inorganic adhesive MA and define air ventilating portions PC1 and PC2. The supporting portion 21a, having a cylindrical shape, allows insertion of the column-shaped second sealing portion 14. A clearance NT defined between the supporting portion 21a and the second sealing portion 14 is filled with the inorganic adhesive MA. Accordingly, the sub-reflecting portion 21b can be fixed in a state of being aligned with the light-emitting portion 11. The column-shaped four partitions 21c having the size equivalent to the width of the clearance NT are tightly fitted into the clearance NT between the supporting portion 21a and the second sealing portion 14 at predetermined spaces. In other words, the clearance NT is divided into four spaces by the partitions 21c. From among these four spaces, the spaces on the +X side and on the −X side other than the spaces on the +Y side and on the −Y side are filled with the inorganic adhesive MA. Consequently, the cooling air ventilating portion PC1 and the auxiliary air ventilating portion PC2 penetrated in the direction of the optical axis are formed as remaining parts of the clearance NT without being filled with the inorganic adhesive MA. By restricting the area to be bonded with the inorganic adhesive MA using the partitions 21c, the cooling air ventilating portion PC1 can be formed at a position corresponding to the upper portion TP of the light-emitting portion 11 so as to have a predetermined size.

The partitions 21c are formed of resilient members. The partitions 21c are arranged so as to come into abutment with the inner periphery of the supporting portion 21a and the outer periphery of the second sealing portion 14 in detail. Therefore, when aligning the sub-reflecting portion 21b with respect to the light-emitting portion 11, the alignment is achieved by resilient deformation of the partitions 21c.

As shown in FIG. 1, the cooling air A flows from the upper side, that is, from the +Y side so as to cool the upper portion TP of the light-emitting portion 11. The cooling air ventilating portion PC1 is formed at a position corresponding to the upper portion TP of the light-emitting portion 11. In other words, the cooling air ventilating portion PC1 allows passage of the cooling air A flowing through the upper portion TP. In this manner, with the provision of the cooling air ventilating portion PC1, the cooling air A passing through the upper portion TP flows between the sub-mirror 21 and the periphery thereof, that is, between the sub-mirror 21 and the light-emitting portion 11 which are further liable to accumulate heat. Accordingly, the light-emitting portion 11 and the sub-mirror 21 can be cooled adequately. Part of the cooling air A flows into the lower portion of the light-emitting portion 11. Such part of the air passes through the auxiliary air ventilating portion PC2. By allowing passage of the part of the cooling air A through the auxiliary air ventilating portion PC2, the cooling effect of the sub-mirror 21 is further enhanced.

As described above, in the light source 100 according to the embodiment, the sub-mirror 21 includes the cooling air ventilating portion PC1 which penetrates in the direction of optical axis at least on the side opposite from the direction of gravitational force out of the mounting portion FP supporting the sub-reflecting portion 21b as the main body portion. Accordingly, the cooling air A can be flowed between the upper portion TP of the light-emitting portion 11 on the opposite side from the direction of gravitational force and the sub-mirror 21, which is liable to accumulate heat. In other words, cooling of the sub-mirror 21 and the periphery thereof is achieved appropriately. In addition, when the auxiliary air ventilating portion PC2 is provided, the cooling effect of the sub-mirror 21 is further enhanced.

Since the partitions 21c are formed of the resilient members, the alignment is achieved by the resilient deformation of the partitions 21c. Therefore, even when the partitions 21c are disposed in abutment with the inner periphery of the supporting portion 21a and the outer periphery of the second sealing portion 14, the alignment is adequately achieved. With the provision of the partitions 21c as describe above, the cooling air ventilating portion PC1, the auxiliary air ventilating portion PC2, and the clearance NT filled with the inorganic adhesive MA can be partitioned reliably.

B. Light Source according to Modification of First Embodiment

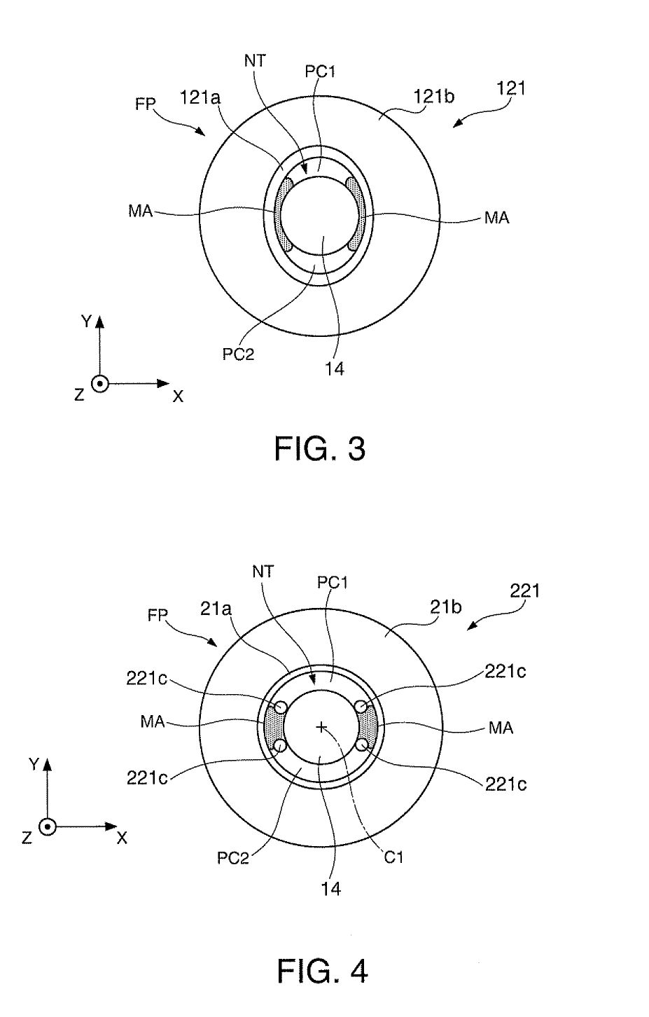

Referring now to FIG. 3, the light source according to a modification of a first embodiment will be described. FIG. 3 is a drawing of a sub-mirror for explaining a modification of the light source. The structures other than the sub-mirror are the same as those of the light source 100 shown in FIG. 1. Therefore, illustration and the description of those other than the sub-mirror will be omitted. As shown in FIG. 3, a supporting portion 121a of the mounting portion FP of a sub-mirror 121 for inserting the second sealing portion 14 has an ellipsoidal cross-sectional shape having a longer diameter in the direction of the ±Y side along the XY plane. The shape and the structure of a sub-reflecting portion 121b of the sub-mirror 121 are the same as those of the sub-reflecting portion 21b shown in FIG. 1. In this case, while the second sealing portion 14 has a column shape and has a circular cross section along the XY plane, the supporting portion 121a has a cross section or inner diameters of an ellipsoidal shape along the XY plane. Therefore, the width of the clearance NT between the supporting portion 121a and the second sealing portion 14 is larger on the ±Y side than on the ±X side. Therefore, when the inorganic adhesive MA is filled from two points in the clearance NT, that is, the +X side and the −X side, of the clearance NT, the cooling air ventilating portion PC1 and the auxiliary air ventilating portion PC2 penetrating in the direction of the optical axis are formed on the ±Y side as points remained without being filled with the inorganic adhesive MA. In manufacture of the sub-mirror 121, a portion of the supporting portion 121a can be formed relatively easily by deforming the portion of the supporting portion 21a of the sub-mirror 21 shown in FIG. 1 for example. In the case of this modification, the sub-mirror 121 and the periphery thereof can be cooled sufficiently by the cooling air A passing through the cooling air ventilating portion PC1 and the auxiliary air ventilating portion PC2 in the same manner as the example described above shown in FIG. 2A.

In the light source 100 described thus far, the reflector 2 can be formed into a parabolic surface and, in this case, the concave lens 3 can be omitted.

### C. Light Source According to Another Modification of First Embodiment

Referring now to FIG. 4, the light source according to another modification of the first embodiment will be described. FIG. 4 is a drawing of a sub-mirror for explaining a modification of the light source. More specifically, FIG. 4 is a drawing of a modification of the partitions shown in FIGS. 2A and 2B. The structures other than the sub-mirror are the same as those of the light source 100 shown in FIG. 1. Therefore, illustration and the description of those other than the sub-mirror will be omitted.

As shown in FIG. 4, the outer diameter of column-shaped four partitions 221c which constitute sub-mirror 221 is formed to be smaller that of the partitions 21c. The partitions 221c are formed of rigid members instead of the resilient members. The supporting portion 21a is configured in such a manner that when the supporting portion 21a is moved toward a center of outer diameter C1 of the second sealing portion 14 including the partitions 221c, the movable distance is set to be 0.5 mm. The partitions 221c are disposed on the outer periphery of the second sealing portion 14 at predetermined spaces, and are bonded initially with the inorganic adhesive MA or the like in a simplified manner. The second sealing portion 14 is configured to be inserted into the supporting portion 21a.

When the sub-reflecting portion 21b is aligned with the light-emitting portion 11, as it has a movable distance 0.5 mm (it may be larger than 0.5 mm), the alignment can be achieved without the resilient deformation of the partitions 221c. After the alignment, the space between the supporting portion 21a and the second sealing portion 14 is divided into four spaces by the partitions 221c. From among these four spaces, the spaces on the +X side and on the −X side other than the spaces on the +Y side and on the −Y side are filled with the inorganic adhesive MA, so that the cooling air ventilating portion PC1 and the auxiliary air ventilating portion PC2 are defined. Although a clearance is formed between the supporting portion 21a and the partitions 221c, the inorganic adhesive MA can be filled therein without flowing into the cooling air ventilating portion PC1 and the auxiliary air ventilating portion PC2 due to its viscosity.

In this manner, since the distance (clearance) required for alignment is secured in the configuration including the partitions 221c and setting the distance that the supporting portion 21a is movable toward the center of outer diameter C1 of the second sealing portion 14 to 0.5 mm or larger, the alignment can be achieved adequately without being affected by the material of the partitions.

### D. Projector

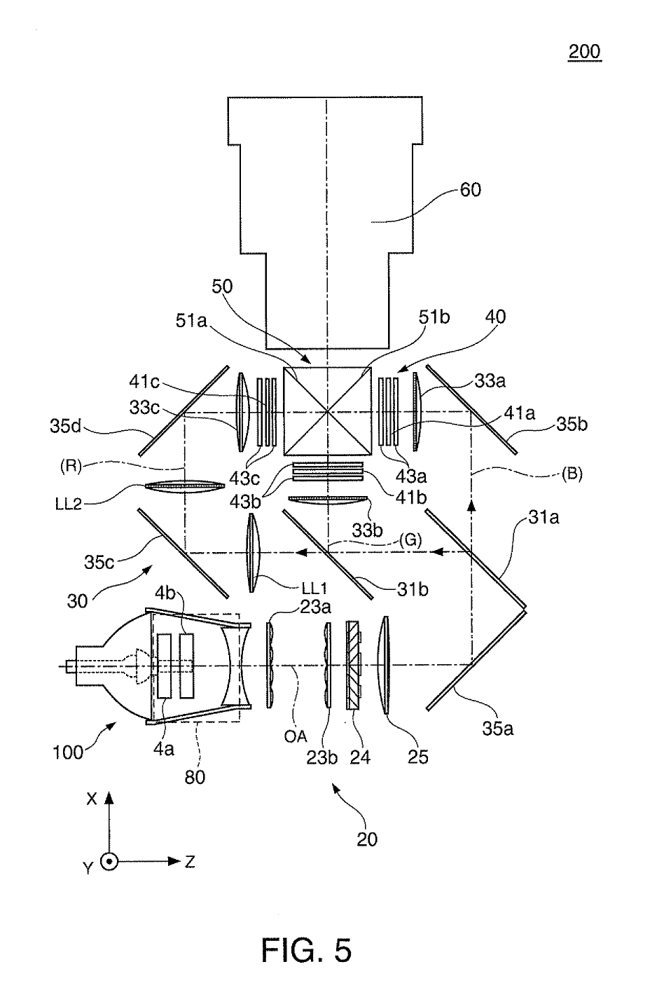

A projector according to the first embodiment will be described. FIG. 5 is a conceptual drawing for explaining a configuration of an optical system of the projector. A projector 200 includes the light source 100 shown in FIG. 1 integrated therein. The projector 200 includes the light source 100, a uniformizing optical system 20 configured to uniformize and emit light source light, a color separation light guiding unit 30 configured to separate the light source light passed through the uniformizing optical system 20 into three colors, namely, red, green, and blue, a light modulating portion 40 illuminated by the light source lights in respective colors exiting from the color separation light guiding unit 30, a color combining unit 50 configured to combine image lights in respective colors from the light modulating portion 40, and a projection lens 60 which is a projection system for projecting an image light passed through the color combining unit 50 onto a screen, not shown. These components are arranged along the optical axis OA in sequence.

As already described, the light source 100 includes the arc tube 1, the reflector 2, the concave lens 3, the sub-mirror 21, and the housing 4. In the projector 200, a cooling fan 80, which is a cooling device for blowing cooling air, is attached to the air supply port 4a for intaking the cooling air of the light source 100. The cooling fan 80 is composed of, for example, a sirocco fan or the like, and blows the cooling air A flowing as shown in FIG. 1 into the light source 100.

The uniformizing optical system 20 includes a pair of first lens array 23a and second lens array 23b, a polarization converting member 24, and a superposing lens 25. The pair of first lens array 23a and the second lens array 23b includes a plurality of element lenses arranged in a matrix pattern, and the element lenses separate the luminous flux from the light source 100 and cause the same to converge and diffuse individually. The polarization converting member 24 aligns the polarized state of the optical flux exiting from the second lens array 23b into an S-polarized light vertical to the paper plane and supplies the same to a downstream optical system. The superimposing lens 25 enables superimposed illumination onto liquid crystal panels 41a, 41b, and 41c for respective colors provided in the light modulating portion 40 as a light modulating device by causing the luminous flux passed through the polarization converting member 24 to generally converge as needed.

The color separation light guiding unit 30 includes first and second dichroic mirrors 31a and 31b, reflection mirrors 35a, 35b, 35c, and 35d, three field lenses 33a, 33b, and 33c, and relay lenses LL1 and LL2. Here, the first dichroic mirror 31a reflects red light and green light and allows blue light to pass therethrough out of three colors of red, green, and blue. The second dichroic mirror 31b reflects for example, green light and allows red light to pass therethrough out of incoming red and green. In the color separation light guiding unit 30, the optical path of the luminous flux of substantially white color from the light source 100 is bent by the reflection mirror 35a to enter the first dichroic mirror 31a. Then, the blue light passed through the first dichroic mirror 31a passes through the reflection mirror 35b in a state of being, for example, S-polarized light, and enters the field lens 33a. The green light reflected from the first dichroic mirror 31a and then further reflected from the second dichroic mirror 31b enters the field lens 33b in a state of being, for example, S-polarized light. The red light passed through the second dichroic mirror 31b passes through the relay lenses LL1 and LL2 and the reflection mirrors 35c and 35d in the state of, for example, being S-polarized light, and enters the field lens 33c for adjusting the incident angle.

The light modulating portion 40 includes three liquid crystal panels 41a, 41b, and 41c, and three sets of polarization filters 43a, 43b, and 43c arranged so as to interpose the respective liquid crystal panels 41a, 41b and 41c therebetween. The liquid crystal panel 41a for blue light and the pair of polarization filters 43a and 43a placed on both sides thereof constitute a liquid crystal light valve for blue light for modulating the luminance of the blue light in the optical flux two-dimensionally on the basis of image information. In the same manner, the liquid crystal panel 41b for green light and the corresponding polarization filters 43b and 43b constitute a liquid crystal light valve for green light, and the liquid crystal panel 41c for red light and the polarization filters 43c and 43c constitute a liquid crystal light valve for red light.

Blue light separated by being passed through the first dichroic mirror 31a of the color separation light guiding unit 30 enters the liquid crystal panel 41a for blue light via the field lens 33a. Green light separated by being reflected from the second dichroic mirror 31b of the color separation light guiding unit 30 enters the liquid crystal panel 41b for green light via the field lens 33b. Red light separated by being passed through the second dichroic mirror 31b enters the liquid crystal panel 41c for red light via the field lens 33c. The lights in three colors entering the respective liquid crystal panels 41a, 41b, and 41c are modulated according to drive signals or image signals entered into the respective liquid crystal panels 41a, 41b, and 41c as electric signals. In this case, the directions of polarization of the luminous fluxes entering the respective liquid crystal panels 41a, 41b, and 41c are accurately adjusted by the polarization filters 43a, 43b, and 43c, and component lights in the predetermined directions of polarization are taken out as image lights from the modulation lights exiting from the respective liquid crystal panels 41a, 41b, and 41c.

The color combining unit 50 is a cross dichroic prism for combining color images and includes a first dichroic filter 51a for reflecting blue light and a second dichroic filter 51b for reflecting red light arranged in an X-shape in plan view in the interior thereof. The color combining unit 50 reflects the blue light from the liquid crystal panel 41a from the first dichroic filter 51a and causes the same to exit rightward in the direction of travel, causes the green light from the liquid crystal panel 41b to travel straight ahead and exit via the first and second dichroic filters 51a and 51b, and causes red light from the liquid crystal panel 41c to reflect from the second dichroic filter 51b and exit leftward in the direction of travel.

The projection lens 60 projects a color image light combined in the color combining unit 50 on a screen in a predetermined scale. In other words, color moving images or color still images having desired scales corresponding to the drive signals or the image signals entered into the respective liquid crystal panels 41a, 41b, and 41c are projected on the screen.

In the projector 200 having the configuration as described above, since the light source 100 shown in FIG. 1 is employed, the cooling air A is flowed between the sub-mirror 21 and the light-emitting portion 11 of the arc tube 1 to cool the sub-mirror 21 and the periphery thereof adequately. Accordingly, heat generation, for example, at the upper portion TP of the light-emitting portion 11 can be restrained. Consequently, the life of the light source 100 and hence the projector 200 is elongated.

### Second Embodiment

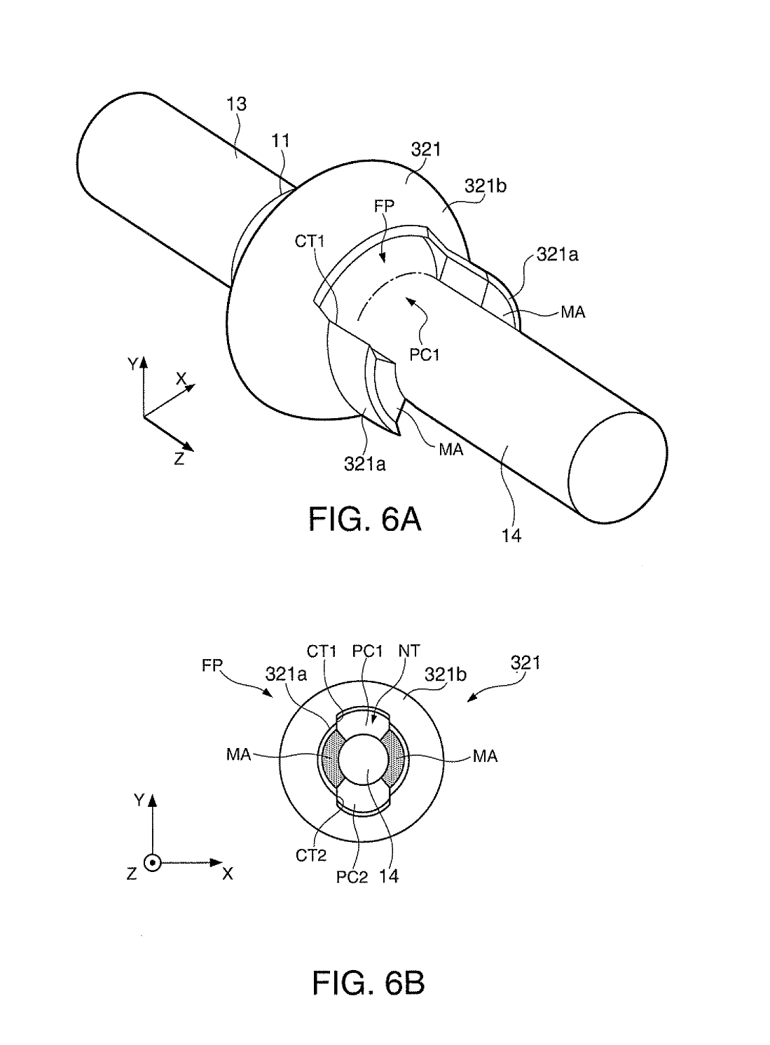

Referring now to FIG. 6A, the light source according to a second embodiment will be described. The light source according to the second embodiment is a modification of the light source 100 in the first embodiment shown in FIG. 1, and is the same as in the first embodiment except for the structure of a sub-mirror 321 unless otherwise specified. Therefore, illustration and description about the configurations of those other than the sub-mirror 321 are omitted. It is also possible to apply the light source according to the second embodiment to a projector. In other word, the light source according to the second embodiment can be applied to the projector 200 instead of the light source 100.

The sub-mirror 321 of the light source according to the second embodiment shown in FIGS. 6A and 6B includes cutouts CT1 and CT2 on the mounting portion FP. As illustrated, the cutout CT1 is formed by cutting parts of a supporting portion 321a on the side and a sub-reflecting portion 321b on the side of the sub-mirror 321. In the same manner, the cutout CT2 is formed by cutting parts of the supporting portion 321a on the −Y side and the sub-reflecting portion 321b on the −Y side. Therefore, in the second embodiment, fixation is performed by filling two points of the clearance NT between the second sealing portion 14 and the supporting portion 321a on the +X side and the −X side of the supporting portion 321a which is remained without being cut with the inorganic adhesive MA and no inorganic adhesive MA is filled on the ±Y side. In this case, the cutouts formed as the cutouts CT1 and CT2 correspond to the cooling air ventilating portion PC1 and the auxiliary air ventilating portion PC2 penetrating in the direction of the optical axis. In the case of the second embodiment as well, the sub-mirror 321 and the periphery thereof can be cooled adequately by the cooling air A passing through the cooling air ventilating portion PC1 and the auxiliary air ventilating portion PC2.

### Other Modifications

The invention has been described in conjunction with the embodiments. However, the invention is not limited to the embodiments described above, and may be implemented in various modes without departing the scope of the invention. For example, following modifications are also applicable.

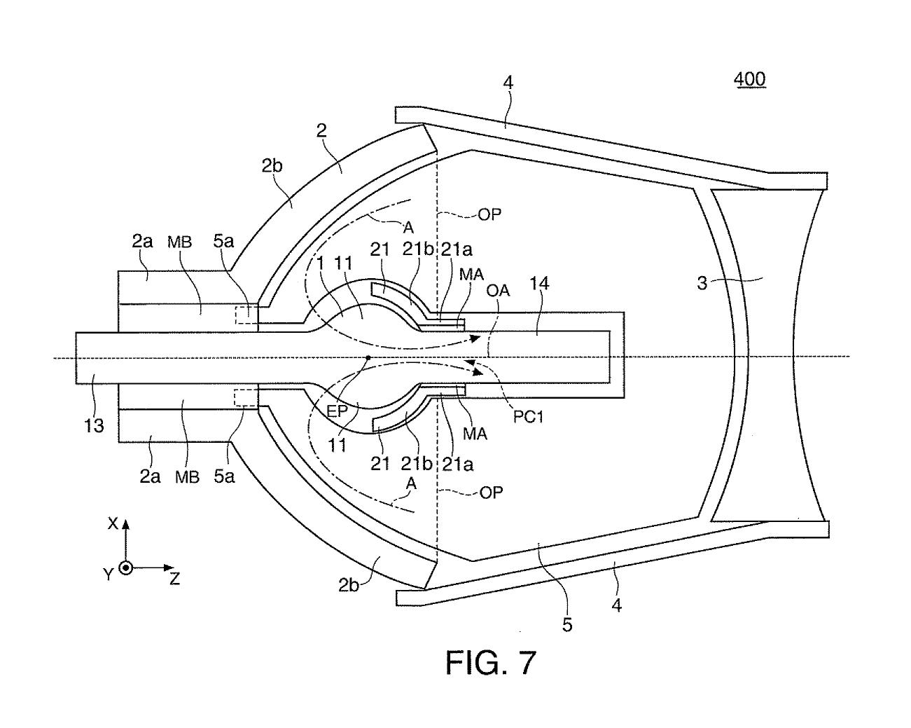

As shown in FIG. 7, a configuration in which the light source 100 shown in FIG. 1 further includes an air flow control panel. More specifically, a light source 400 in FIG. 7 has the same configuration as the light source 100 shown in FIG. 1 regarding the arc tube 1 and the sub-mirror 21, and further includes an air flow control panel 5 for adjusting the direction of flow of the cooling air A. More specifically, the air flow control panel 5 is a thin panel having a plane including the optical axis OA and extending in parallel with the XZ plane and, for example, formed of low thermal expansion glass such as quartz, and has a light-transmitting property with respect to the light source light emitted from the arc tube 1. A reflection preventing coat is formed on the surface of the air flow control panel 5, which prevents the efficiency of light utilization from lowering. The air flow control panel 5 divides the internal space of the housing 4 into the upper side and the lower side while remaining a small space. Furthermore, projections 5a for fixation are formed on a root side of the air flow control panel 5, and the projections 5a are fixed using the inorganic adhesive MB filled in the neck-shaped portion 2a of the reflector 2. In this configuration, the air flow control panel 5 allows the cooling air A to flow on the upper side of the light-emitting portion 11 on the priority basis. Furthermore, in this case, since the air flow control panel 5 extends to the neck-shaped portion 2a of the reflector 2, the air flow control panel 5 can control the flow of the cooling air A flowing along the inner side of the reflector 2 to be turned and directed along the optical axis from the reflector 2 side toward the sub-mirror 21 side in cooperation with the inner surface of the reflector 2.

In the description given above, the auxiliary air ventilating portion PC2 penetrating in the direction of optical axis is formed on the side of the direction of gravitational force. However, a structure having only the cooling air ventilating portion PC1 and not having the auxiliary air ventilating portion PC2 is also applicable. In contrast, another air ventilating portion penetrating in the direction of optical axis may be provided in addition to the air ventilating portions PC1 and PC2. For example, in the first embodiment, there are provided four of the partitions 21c are used for the sub-mirror 21. However, the number of the partitions may further be increased.

In the modification of the first embodiment described above, the cross-sectional shape of the supporting portion 121a of the sub-mirror 121 is ellipsoid. However, it may be a similar shape instead of a complete ellipsoid as long as the length in the Y direction is longer than the length in the X direction.

In another modification of the first embodiment described above, the partitions 221c are disposed on the outer periphery of the second sealing portion 14 at predetermined spaces, and are bonded initially with the inorganic adhesive MA or the like in a simplified manner. However, the partitions 221c may be disposed on the inner periphery of the supporting portion 21a at predetermined spaces, and are bonded initially with the inorganic adhesive MA or the like in a simplified manner.

In the housing 4 of the light source 100 of the projector 200, for example, it is to provide the air supply port 4a and the air discharge port 4b also on the wall surface in the −Y direction to allow the air flow to be flowed switchably from the +Y side and the −Y side so that the flow control of the cooling air A can be changed when the projector 200 is used as a suspending type which is used in a vertically inverted position. In this case, when using the projector 200 as the suspending type, the air ventilating portion PC2 serves as a main cooling air ventilating portion, and the air ventilating portion PC1 serves as an auxiliary air ventilating portion.

In the above-described projector 200, the uniformizing optical system 20 includes the pair of first lens array 23a and second lens array 23b, the polarization converting member 24, and the superimposing lens 25. However, the first lens array 23a, the second lens array 23b, and the polarization converting member 24 can be omitted. In addition, the first lens array 23a and the second lens array 23b can be replaced with a rod integrator.

Alternatively, instead of the color separation light guiding unit 30 or the light modulating portion 40, light-modulation and combining of the respective colors may be achieved by using a combination of a color wheel illuminated by the light source 100 and the uniformizing optical system 20, and a digital micromirror device irradiated with transmitted light from the color wheel.

In the description given above, the example in which the invention is applied to the transmissive projector has been described. However, the invention may be applied also to the reflective projector. The term “transmissive” means that the liquid crystal light valve including the liquid crystal panel is of a transmissive type, and the term “reflective” means that the liquid crystal light valve is of a type reflecting the light.

What is claimed is:

1. A light source comprising:
an arc tube having a light-emitting portion having a discharge space in the interior thereof and first and second sealing portions provided on both sides of the light-emitting portion along an optical axis;
a reflector arranged so that a center where the optical axis passes is located on the side of the first sealing portion with respect to the light-emitting portion, and having a main reflecting surface configured to reflect a luminous flux emitted from the light-emitting portion; and
a sub-mirror arranged on the side of the second sealing portion so as to oppose the reflector, the sub-mirror includes,
a main body portion provided with a sub-reflecting surface configured to reflect part of a luminous flux emitted from the arc tube toward the discharge space,
a mounting portion configured to be fixed to the second sealing portion and supporting the main body portion, and
a cooling air ventilating portion penetrating through the mounting portion in the direction of the optical axis at least on the opposite side from the direction of gravitational force.

2. The light source according to claim 1, wherein
the sub-mirror further includes an auxiliary air ventilating portion penetrating in the direction of the optical axis on the side of the direction of the gravitational force.

3. The light source according to claim 1, wherein
the second sealing portion has a cylindrical shape, and
the mounting portion includes a supporting portion having an ellipsoidal-shaped cross section and allowing insertion of the second sealing portion.

4. The light source according to claim 1, wherein
the mounting portion includes:
a supporting portion configured to allow insertion of the second sealing portion,
an adhesive to be filled in a space between the second sealing portion and the supporting portion, and
a partition configured to restrict a range to be bonded with the adhesive and define the air ventilating portion.

5. The light source according to claim 4, wherein
the partition is formed of a resilient member.

6. The light source according to claim 4, wherein
the distance that the supporting portion including the partition can be moved toward a center of outer diameter of the second sealing portion is 0.5 mm or more.

7. The light source according to claim 1, wherein
the cooling air ventilating portion is a cutout provided on the side of the mounting portion of the sub-mirror.

8. The light source according to claim 1, further comprising:
an air flow control panel configured to direct the cooling air from the side of the reflector to the side of the sub-mirror along the optical axis in cooperation with a inner surface of the reflector.

9. A projector configured to perform image projection by modulating light emitted from the light source according to image information and forming image light comprising:
a light source according to claim 1.

10. The projector according to claim 9,
the sub-mirror further includes an auxiliary air ventilating portion penetrating in the direction of the optical axis on the side of the direction of the gravitational force.

11. The projector according to claim 9, wherein
the second sealing portion has a cylindrical shape, and the mounting portion includes a supporting portion having an ellipsoidal-shaped cross section and allowing insertion of the second sealing portion.

12. The projector according to claim 9, wherein
the mounting portion includes:
a supporting portion configured to allow insertion of the second sealing portion,
an adhesive to be filled in a space between the second sealing portion and the supporting portion, and
a partition configured to restrict a range to be bonded with the adhesive and define the air ventilating portion.

13. The projector according to claim 12, wherein
the partition is formed of a resilient member.

14. The projector according to claim 12, wherein
the distance that the supporting portion including the partition can be moved toward an center of outer diameter of the second sealing portion is 0.5 mm or more.

15. The projector according to claim 9, wherein
the cooling air ventilating portion is a cutout provided on the side of the mounting portion of the sub-mirror.

16. The projector according to claim 9, further comprising:
an air flow control panel configured to direct the cooling air from the side of the reflector to the side of the sub-mirror along the optical axis in cooperation with a inner surface of the reflector.

17. The projector according to claim 9, further comprising:
a cooling device configured to blow the cooling air toward the reflector.
